(19) United States
(12) Patent Application Publication
(10) Pub. No.: US 2003/0122656 A1
(43) Pub. Date: Jul. 3, 2003

(54) Fast response safety station

(76) Inventor: Edwin G. Cavil, Green Bay, WI (US)

Correspondence Address: PATRICIA SMITH KING, SUITE 22, 222 NORTH MIDVALE BOULEVARD, MADISON, WI, 537055072

(21) Appl. No.: 10/034,722

(22) Filed: Dec. 28, 2001

(51) Int. Cl. G08B 25/00

(52) U.S. Cl. 340/287

(57) ABSTRACT

A safety station for rapid response to a safety incident. The safety station comprises an alarm unit and optionally also a response instructional unit located proximate thereto. The alarm unit comprises a support post to which are attached a visual and an audible alarm. The alarms are activated by means of an electrical switch and powered alternatively by an AC power supply provided by a utility company or a DC power supply provided by a battery. The alarm unit further comprises a base that may be variably adapted for mounting the alarm unit to a variety of surfaces and in a variety of substrates, including in dirt or gravel such as might be found at a construction site. The instructional unit generally comprises a computer and touch-screen display located proximate the alarm unit and at which instructions may be immediately accessed to address a plurality of types of safety incidents, to allow a user to begin responding appropriately to the particular incident, even prior to the arrival of others summoned by the alarms. The computer of the instructional station may be a self-contained unit or may be connected via a local area network to a server that provides the instructional materials to the site. The alarm unit is weatherproof and the instructional unit may likewise be adapted for use in adverse environments by means of an enclosure.

### BACKGROUND

Key to the safety of employees in most work environments, is the ability to quickly find and sound an alarm that will alert others to the existence and location of a dangerous safety or emergency incident when it occurs. It is furthermore vital for workers personally involved or otherwise at the scene of an incident, to rapidly respond appropriately to the particular situation. When seconds count, an immediate and appropriate response prior to the arrival of trained emergency response personnel, can mean the difference between life and death. For these reasons, an alarm station must be conveniently locatable proximate worker areas, easily recognizable and readily activatable by workers. The alarm station must furthermore provide easily accessible response instructions for a wide variety of types of safety and emergency situations to inform those present how best to respond to a particular incident. These instructions are necessary in a crisis situation particularly given the wide variety of dangerous incidents possible including severe personal injuries, hazardous spills, weather conditions and the like.

The need for safety alarm systems has been widely recognized. Regulations under the Occupational Safety & Health Administration (OSHA) of the U.S. Department of Labor, for example, require that employee alarms be capable of being perceived by all employees above ambient noise or light levels in the affected portions of a workplace (29 C.F.R. sec. 1910.165(b)(2)). Employers of more than 10 employees are further required to have written response plans prepared, including means for reporting emergencies, such as emergency alarms. For this reason, attempts have been made to make alarm systems sufficient to the task. In manufacturing plants, alarm systems are often limited to emergency shut-off switches on machinery to be activated in the event of a malfunction. These alarms are often not of a kind easily identifiable at a moment of crisis nor are they appropriate to other types of safety situations. Rarely do they also provide easily accessible instructions on a wide variety of types of incidents. At construction or other remote sites alarms are often not present at all.

Information relevant to attempts to address these problems can be found in U.S. Pat. No. 5,990,796 to Hsu, U.S. Pat. No. 6,226,510 to Boling et al., U.S. Pat. No. 6,028,513 to Addy, U.S. Pat. No. 4,988,980 to Graham, U.S. Pat. No. 6,052,052 to Delmonaco, U.S. Pat. No. 4,531,114 to Topol et al., U.S. Pat. No. 6,127,935 to Davidson et al., U.S. Pat. No. 6,144,310 to Morris, U.S. Pat. No. 6,097,289 to Li et al., and U.S. Pat. No. 6,060,979 to Eichsteadt. However, each one of these references suffers from one or more of the following disadvantages: it does not combine both sound and visual alarms to maximize warning capability; it is not easily recognizable at a time of crisis; it is not locatable in a variety of work environments; it is not easily activated by workers at the site of an incident; it cannot be variably mounted to enable installation in a wide variety of situations; it does not function at remote worker sites and in all-weather conditions; or, it does not provide immediate instruction in how to respond to a wide variety of types of safety or emergency incidents.

For the foregoing reasons, there is a need for an easily recognizable alarm unit that can be installed in a variety of work environments and that can notify others of a safety incident occurrence and location by alarm. There is also a need for an alarm unit that can provide immediate access to response instructions that cover a wide variety of types of situations in order that workers at the site of an incident may respond appropriately and immediately before the arrival of emergency personnel, when the immediacy of an appropriate response may make the difference between life and death.

### SUMMARY

The present invention is directed to an apparatus that satisfies this need. The apparatus is a safety station comprising an alarm unit alone or in combination with an instructional unit. When comprised of both, the safety station provides in one place both an alarm and instructions for responding to a safety incident. The alarm unit contains both visual and audio alarms, each triggered by a manually activated electrical switch. The alarms are supported at the upper end of a support post so as to enable clear transmission of the visual and audio alarms. An electrical circuitry connects the alarms with a power supply and the switch serves to actuate the circuit activating the alarms when closed by a user. The electronic circuitry is contained in the hollow interior of the support post for safety. The electrical power supply to the safety station may be a municipal power supply as typically supplied by a utility company, or an alternative power source such as a battery. When power is supplied by a utility company, the safety station may also comprise a backup battery to supply power to the station in the event of an interruption in the municipal power supply. The support post is connected to a base at its lower end that may be adapted for mounting the post in a variety of environments including on cement, in sand or gravel at a construction site, or to a beam or wall. An instructional unit is located proximate the alarm unit for access to safety response instructions at the site of the safety station. The instructional unit is comprised of a computer and display screen from which a variety of safety response instructions may be retrieved by a user. The computer may be an independent unit or may alternatively, be connected to a server via a computer network, the server supplying the safety instructions to the computer at the safety station. In the networked version, many safety stations may be connected and provided information or otherwise controlled by a server located elsewhere. The computer may be supplied with a variety of hardware, including a touch screen or other type of display for ease of use in time of crisis. The safety instructions program may provide the instructions in a variety of media, including graphically and/or audibly via speakers to optimize applicability of the system to a variety of users including the visually or hearing impaired.

Several objects and advantages of the present invention are:

a) means by which a safety station may be provided for use by workers that is easily recognizable and that provides both alarm and/or instructional capabilities at the same site;

b) means by which a safety station may be adapted for use at remote sites, such as construction sites, by provision of variably mountable bases, a battery power supply and weatherproof features; and,

c) means by which a network of safety stations may be provided to insure easy installation of the stations at multiple locations and the transmission of safety response instructions to each station from a central server location.

The reader is advised that this summary is not meant to be exhaustive. Further features, aspects, and advantages of the present invention will become better understood with reference to the following description, accompanying drawings and appended claims.

### BRIEF DESCRIPTION OF DRAWINGS

For a better understanding of the present invention, reference may be made to the accompanying drawings, in which:

FIG. 1, shows a schematic diagram depicting a free-standing version of the alarm unit 200;

FIG. 2, shows a schematic diagram depicting a beam- or wall-mounted version of the alarm unit 200;

FIG. 3a, shows the basic electronic circuitry of the alarm unit 200 powered by an AC power supply;

FIG. 3b, shows the basic electronic circuitry of the alarm unit 200 powered by an AC power supply, with a backup power supply (e.g. battery);

FIG. 3c, shows the basic electronic circuitry of the alarm unit 200 powered by a DC power supply (e.g. battery);

FIG. 3d, shows the basic electronic circuitry of the alarm unit 200 powered by a DC power supply (e.g. battery) with battery recharge status indicator included;

FIG. 4, shows a schematic diagram depicting a version of the safety station 100 comprising an alarm unit 200 in combination with an instructional unit 300, the instructional unit 300 being mounted to the support post 210 of the alarm unit 200;

FIG. 5, shows a schematic diagram depicting a version of the safety station 100 of the present invention in which the instructional unit 300 is supported by a stand proximate the alarm unit 200;

FIG. 6a, shows the basic electronic circuitry of the safety station 100 powered by an AC power supply;

FIG. 6b, shows the basic electronic circuitry of the safety station 100 powered by an AC power supply, with a backup power supply (e.g. battery);

FIG. 6c, shows the basic electronic circuitry of the safety station 100 powered by a DC power supply (e.g. a battery);

FIG. 6d, shows an example of the electronic circuitry of the safety station 100 where the instructional unit 200 and alarm unit 300 are run on different power supplies; and,

FIG. 7, shows a version of the present invention in which the computers 310 of multiple safety stations 200 are connected via a local area network to a central server 330.

### REFERENCE NUMERALS IN DRAWINGS

100 safety station

200 alarm unit

210 support post of alarm unit 200

220 visual alarm means of alarm unit 200

230 audio alarm means of alarm unit 200

240 electrical switch of alarm unit 200

250 base of alarm unit 200

260 DC power supply (e.g. battery)

262 battery recharge status indicator

270 AC power supply

280 backup power supply (e.g. battery)

290 solid state relay

292 resistor array

300 instructional unit

310 computer of instructional unit 300

320 display screen of instructional unit 300

330 server

### DESCRIPTION

Referring now specifically to the figures, in which identical or similar parts are designated by the same reference numerals throughout, a detailed description of the present invention is given. It should be understood that the following detailed description relates to the best presently known embodiment of the invention. However, the present invention can assume numerous other embodiments, as will become apparent to those skilled in the art, without departing from the appended claims. For example, though described as applicable to work environments such as manufacturing facilities, construction sites and the like, the present invention may also be applied to public and other environments in which safety is an issue. The present invention could be easily adapted to serve its safety function almost anywhere including along public streets, at sports stadiums, in public buildings or in private homes.

It should also be understood that the applicant intends to encompass within the language of this description, any structure presently existing or developed in the future that performs the same function.

It should furthermore be understood that, while the methods disclosed herein may be described and shown with reference to particular steps performed in a particular order, these steps may be combined, sub-divided, or re-ordered to form an equivalent method without departing from the teachings of the present invention. Accordingly, unless specifically indicated herein, the order and grouping of the steps is not a limitation of the present invention.

Overview

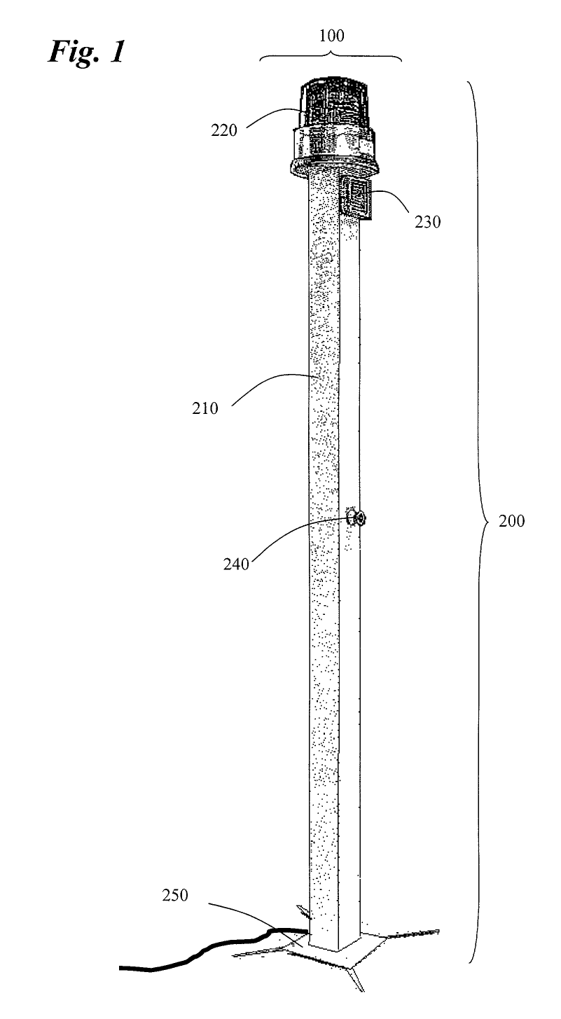

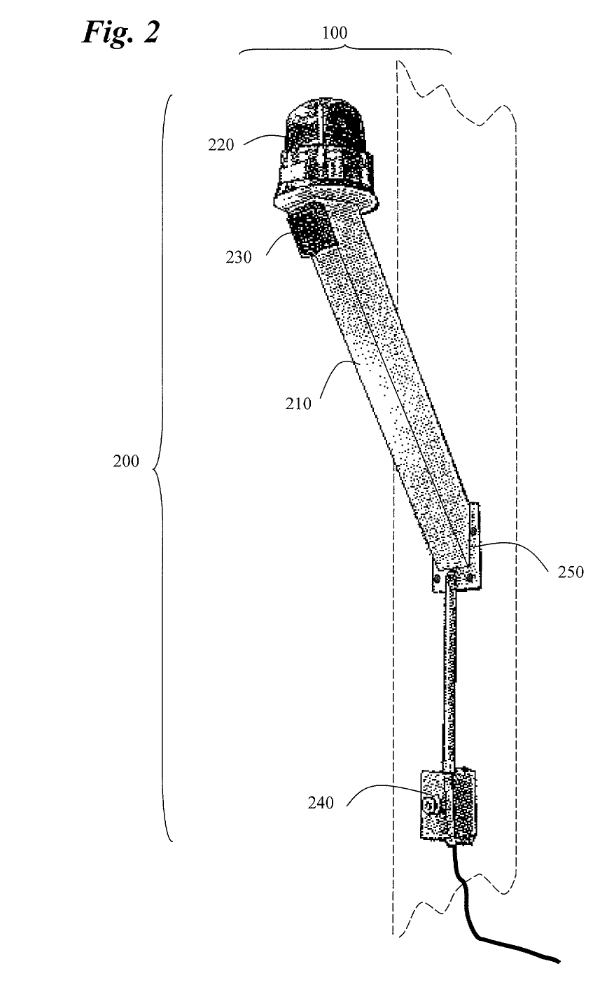

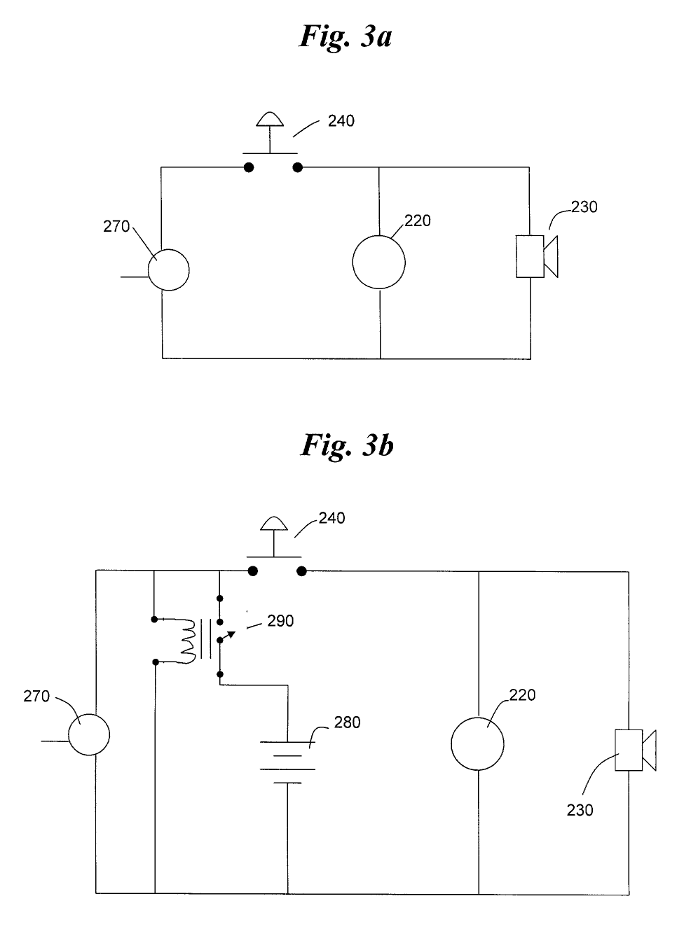

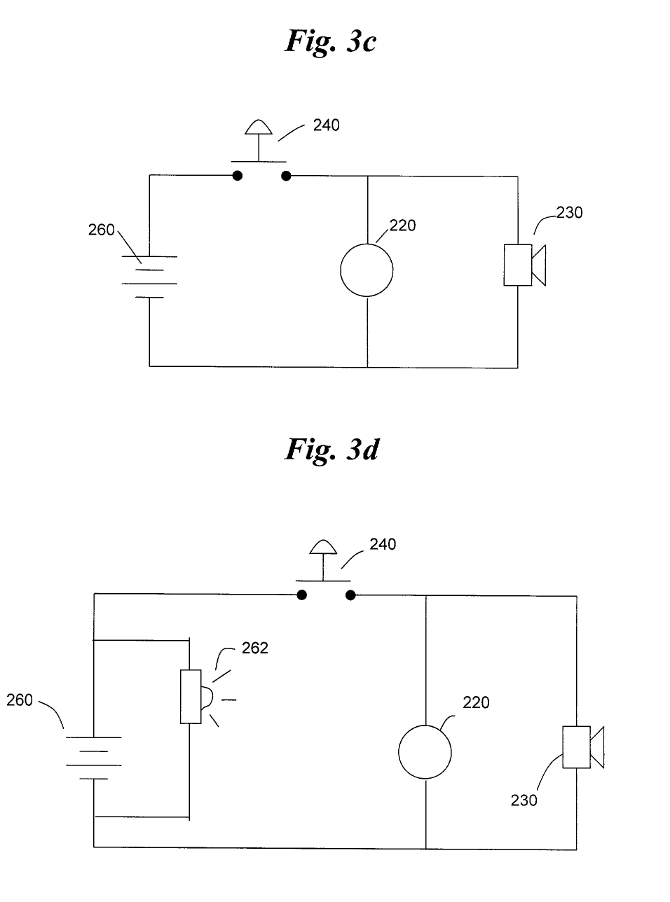

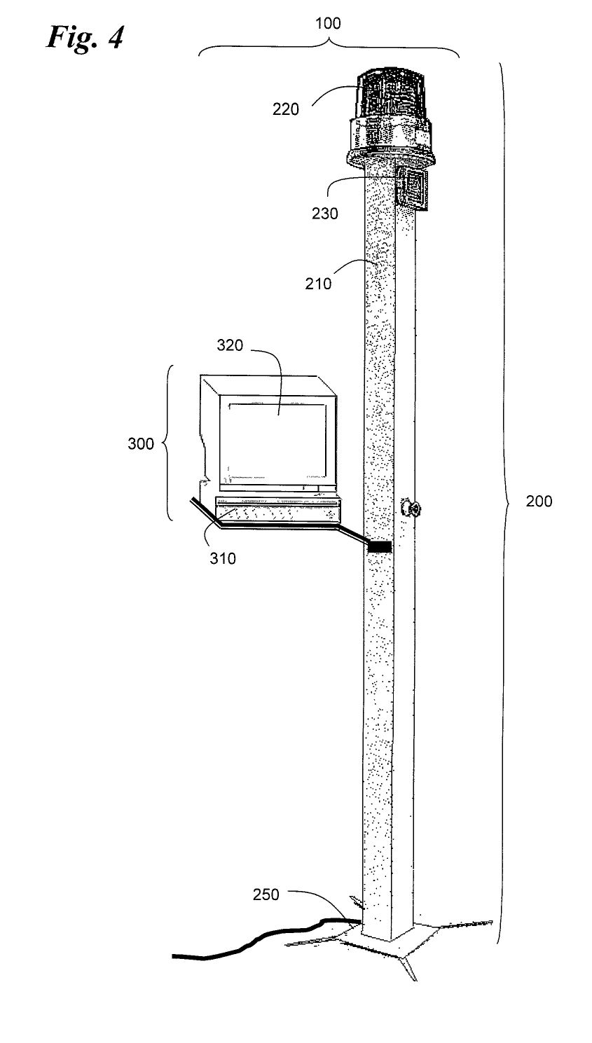

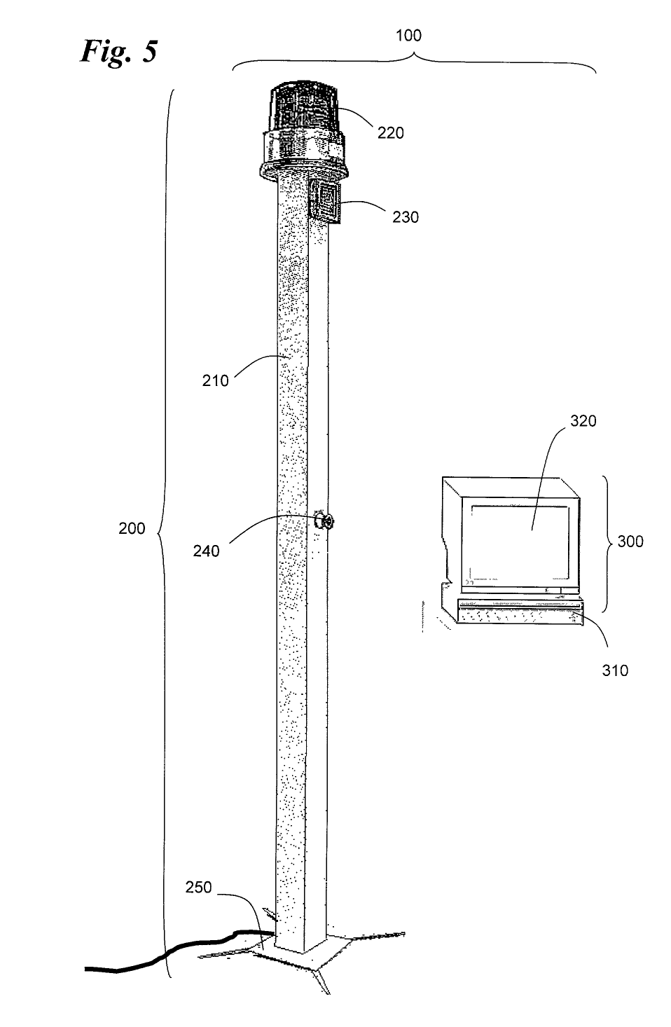

As shown in FIG. 1, the safety station 100 of the present invention comprises an alarm unit 200. The alarm unit 200 of the present invention comprises a support post 210 with visual alarm means 220 and audible alarm means 230 attached to an upper end thereof. Each alarm means is connected via electrical circuitry to a power supply (260 or 270, see FIGS. 3a-3d) and activated by an electrical switch 240. The alarm unit 200 further comprises a base 250 for support that is connected to the lower end of the support post 210. The base 250 may be variably formed to enable mounting of the alarm unit 200 in a variety of ways (e.g. on a wall or beam as illustrated in FIG. 2, or free-standing on a flat surface as illustrated in FIG. 1). The safety station 100 may further comprise an instructional unit 300 which is located proximate the alarm unit 200 to enable the provision of an alarm and incident instructions at the same site (see FIGS. 4 and 5). The instructional unit 300 generally comprises a computer 310 from which safety instructions may be retrieved by a user at a display screen 320.

### DETAILED DESCRIPTION

Referring now to FIG. 1, a version of the safety station 100 comprising solely the alarm unit 200 is depicted. The alarm unit 200 is a weatherproof unit comprising a support post 210 having at least one sidewall defining a hollow interior, an upper end and a lower end. As depicted in FIG. 1, the support post 210 is a square post, but the post may be round or otherwise shaped.

The alarm unit 200 further comprises a visual alarm means 220 and an audible alarm means 230 attached to the upper end of the support post 210. Having a support post 210 that raises the alarm means (220 and 230) to a certain height above ground, functions to aid in the transmission of the alarm signals and to make the alarm unit 200 of the present invention more easily identified by workers when an incident occurs. The support post 210 may come in one or more sub-sections to enable a user to install the alarm unit 200 at various heights. The subsections may be fitted one into the other until the desired height is obtained. The support post 210 may further function to aid in the easy location of the alarm unit 200, when it is provided in a distinctive color, such as red or yellow.

In addition to the functions fulfilled by the support post 210 described above, it may serve as a mounting surface for a variety of accessories available for the safety station 100. Accessories may include communication means (such as phones, intercoms, pagers, and the like), video cameras, first aid kits, storage boxes for information sheets, and the like.

The visual alarm means 220 may consist of a strobe light or other types of lights that provide an intensity of light sufficient to alert people in the vicinity, that a safety incident is occurring. The audible alarm means 230 may consist of a siren as depicted, or other audible alarms such as bells or ringers that provide a sound of sufficient volume to be heard in the vicinity of the safety incident. By providing both a visual alarm means 220 and an audible alarm means 230, the alarm unit 200 is able to alert workers regardless of whether they are visually or hearing impaired.

The visual and audible alarm means (220 and 230 respectively) are connected via electronic circuitry to a power source (260 or 270; see FIGS. 3a-3d). The electronic circuitry is generally disposed within the hollow of the support post 210 in order to ensure the safety of the wiring. The circuitry may or may not extend beyond the post as depicted in FIG. 2, for example. An electrical switch 240 is disposed in the electronic circuitry between the alarm means (220 and 230) and the power source (260 or 270), and serves to control activation of the alarms. The electrical switch 240 is manually activated and may be of a variety of types or on-off switches including a push-pull type switch, flip switch or the like. There may be more than one switch 240 located proximate the support post 210, on the post's surface or nearby. Multiple switches 240 located at various levels from floor or ground surface may enable easier access by workers of various heights and in various positions. For example, a switch 240 may be located at a level accessible to workers in wheel chairs, while another switch 240 may be located at a greater height within easy reach of workers that are standing. Having more than one switch 240, located at various levels may help to ensure that at least one of them will be accessible by workers during a safety incident.

Additionally, the alarms (220 and 230) may be adapted to enable remote triggering. In this way, the alarms may be set off from another location in the event of a safety situation to which personnel located away from the safety station(s) 100 are first alerted.

Referring to FIGS. 3a-3d, several versions of the basic electronic circuitry of the alarm unit 200 of the present invention are depicted in order to illustrate the various basic setups described below. The circuits depicted are meant only to illustrate these basic circuitries and the reader is advised that many variations on these basic circuitries are possible to achieve the same result.

The power source powering the alarm unit 200, as well as the instructional unit 300 of the safety station 100, may be AC (alternating current 270; see FIGS. 3a and 3b) from a municipal power supply as is typically provided to a facility by a utility company. Alternatively, the power source may be DC (direct current 260; see FIGS. 3c and 3d) provided by a battery power supply. Backup power supplies 280 such as batteries or other alternative power supplies may be further employed in versions of the alarm unit 200 powered by a municipal power supply, in order to assure that power to the alarm 200 and instructional 300 units of the alarm unit 200 be uninterrupted during power outages (see FIG. 3b). When battery power sources are employed, either as the main power supply or the backup power supply, there may be a battery recharge status indicator 262 (see FIG. 3d for an illustration of its use with a battery-powered version of the alarm unit 200) associated with them to alert users when the battery is low. The alarm unit 200's circuitry may furthermore include a key-off activation switch to allow shut-off of the alarms.

The support post 210 is mountable to a variety of surfaces by means of the base 250 connected to the lower end of the support post 210. The base 250 functions as a universal mounting apparatus enabling the alarm unit 200 to be secured to a number of different surfaces. For example, the base 250 may provide support so that the alarm unit 200 may be free-standing, as in the version depicted in FIG. 1. It may alternatively be adapted for fastening to a wall or beam as in the version depicted in FIG. 2. The base 250 may be further modified to enable mounting of the alarm unit 200 in a variety of substrates such as dirt or gravel as may be typically found at construction sites, or adapted for more permanent mounting in cement or on wood in a facility. By enabling the alarm unit 200 of the safety station 100 to be mounted at remote locations, such as construction and other sites, it is able to serve an equally important safety function at such sites as it does when installed at facilities.

The instructional unit 300 is located proximate the alarm unit 200. The instructional unit 300 may be attached to the support post 210 of the alarm unit 200 (as in FIG. 4) or it may simply be located nearby on a stand or other supporting structure (as in FIG. 5). Having the instructional unit 300 near the alarm unit 200 enables workers to access safety procedures immediately when a safety incident occurs and at the same time the safety alarms (230 and 240) are activated. After the alarms are tripped, workers may quickly access safety procedural instructions pertaining to the present incident and begin administering an appropriate response because of the instructional unit's 300 proximity to the alarm unit 200.

The instructional unit 300 generally comprises a computer 310 with an easily accessible display screen 320 (FIGS. 4 and 5). The display screen 320 may comprise a touch-screen display for easy access and activation of the computer 310 and program of safety procedure instructions, or it may be activated by means of a mouse or other device. The computer 310 may be of a variety of types, including a laptop for easy mobility between incident sites and use at remote sites, due to its battery power capabilities. The computer 310, display screen 320 and other hardware of the instructional unit 300, may be contained within an enclosure for protection when used in outdoor or otherwise potentially damaging environments. The instructional unit 300 may be supported in such a way as to allow some mobility of the unit to aid in accessing information at the actual site of an incident.

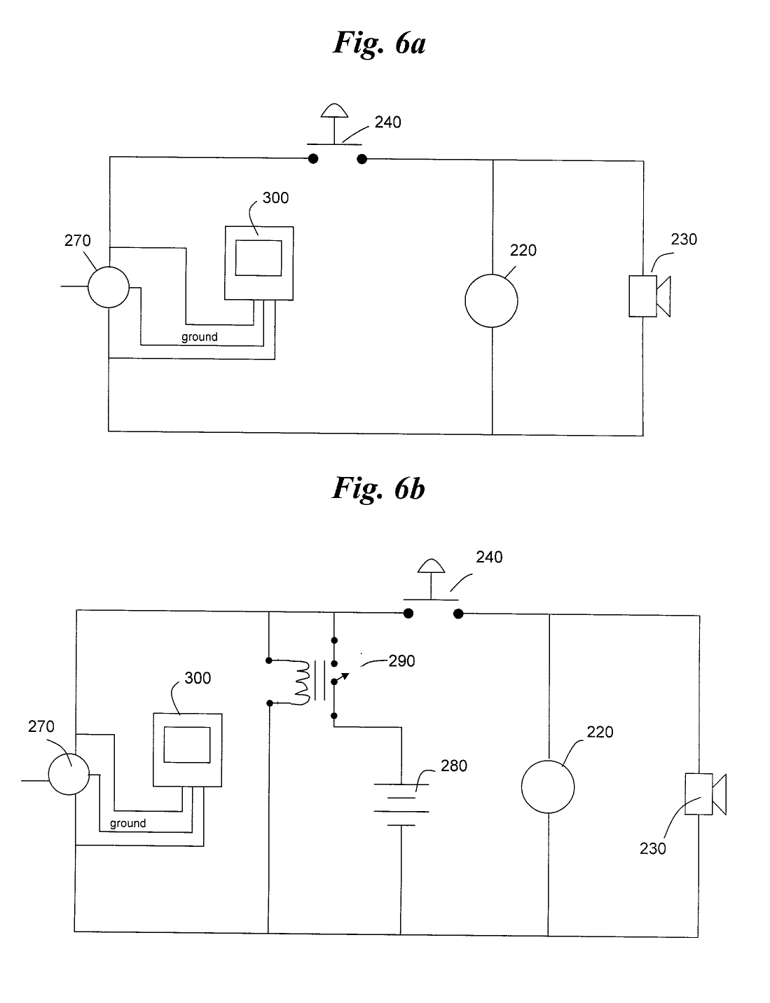

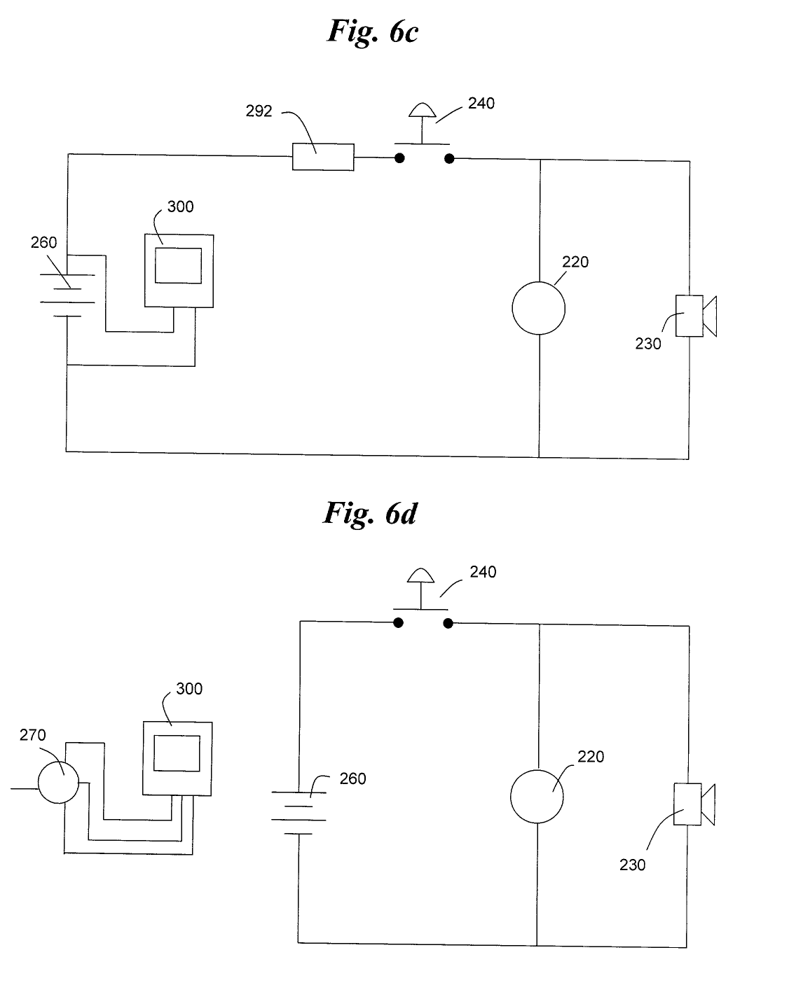

Referring to FIGS. 6a-6d, several versions of the basic electronic circuitry of the safety station 100 of the present invention, including the instructional unit 300, are depicted in order to illustrate the various basic setups described below. The circuits depicted are meant only to illustrate these basic circuitries and the reader is advised that many variations on these basic circuitries are possible to achieve the same result.

Like the alarm unit 200, the instructional unit 300 may be run by municipal or battery power supplies (270 or 260, respectively). For example, the alarm unit 200 and instructional unit 300 may both be powered by a municipal power supply 270 with or without a backup battery power supply 280 as depicted in FIGS. 6a and 6b, respectively (the circuit in FIG. 6b, including a solid state relay 290). Alternatively, both units (200 and 300) may be powered by a battery power supply 260 (FIG. 6c, including a resistor array at 292). In addition, the alarm unit 200 and instructional unit 300 may be powered by different power supplies. For example, the alarm unit 200 may be powered by a battery power supply 260 while its associated instructional unit 300 is powered by a municipal power supply 270 (as in FIG. 6d), or vice versa. The ability to use different power supplies to power the safety station 100 and its subunits, on the same or separate electrical circuits, enables its use in a wider range of work situations than might otherwise be possible.

The safety procedure instructions cover a wide range of incident types and are organized for easy access by a user. For example, if a person has stopped breathing, a user of the instructional unit 300 may first select on the screen display 310, the category for personal injuries that then leads to a next screen displaying subcategories of personal injuries. The user may then select a subcategory for non-breathing, for example, that prompts the display of a next display of the appropriate response protocol, as in:

(a) Tap victim on shoulder and shout, “Are you OK?”

(b) If no response,

a. tilt the victim's head (the display will give further instruction and graphics of the procedure).

b. Immediately look, listen and feel for air (the display will give further instruction and graphics of the procedure).

(c) If victim is not breathing,

a. Give two full breaths (the display will give further instruction and graphics of the procedure).

b. Again, look, and feel for air exchange.

(d) If still no breathing, give one breath every 5 seconds.

Other examples would include instructions for what to do in the event of other types of severe injury, where to go in the event of a fire or tornado, what to do if a hazardous spill has occurred and the like. The programming of the instructional unit 300 may be tailored to a given work environment to include instruction to meet its particular needs in addition to more generic safety instructions. For example, safety instructions for a particular type of chemical plant may differ from those for a metal fabrication plant or for a sports stadium. Likewise, safety instructions may vary by particular facility, including detailed floor-plans and evacuation routes, locations of help stations, shelters, shut-off valves, or the like. Safety instructions may also be tailored to differences in the types of users accessing them. For example, instructions may be presented in a very general and easily understood manner for safety stations 100 located in public places where users may span a broad range of languages and education levels. By contrast, instructions may be presented in a more technical manner for workers of a more uniform background, when the instructional unit 300 is installed for use in a particular industry.

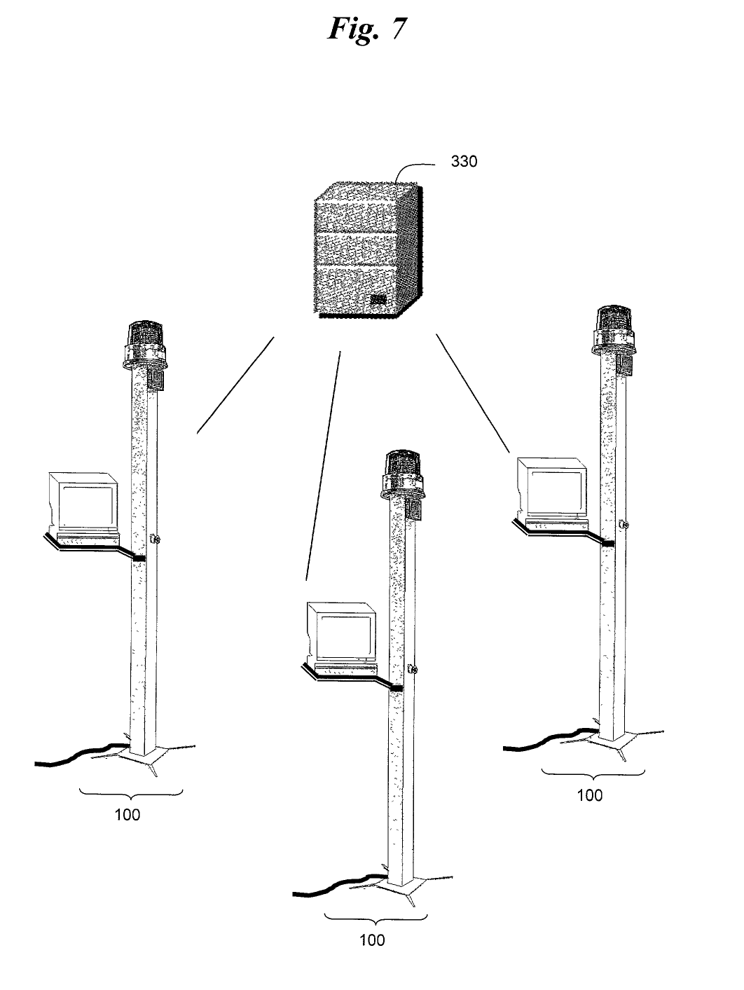

The computer 310 may be an independent unit fully loaded with a safety procedure instructional programming or it may be a workstation connected to a remote server 330 located elsewhere on a computer network, such as a local area network, that provides the safety programming to the workstation from a remote site (as depicted in FIG. 7).

The instructional unit 300 may be accessed independently of the alarm unit 200. In this way, workers may access information pertaining to a variety of safety procedures at non-emergency times without activation of the alarm unit 200. The instructional unit 300 thus serves a tutorial function and aids in maintaining a workforce well-informed about safety procedures.

How the Invention is Used

The safety station 100 of the present invention is designed to be easily located and activated when a safety incident occurs. In such an event, a user trips the electrical switch 240 activating the alarm means (220 and 230). The user may then activate the instructional unit 300 by touching or otherwise activating the screen display 310. The user may then select from among several easily recognized representations of general categories of safety incidents, including severe personal injuries, hazardous spills, fire, severe weather and the like. Activating any of the general category symbols, leads to other more detailed selections and eventually, instructions for a particular type of safety incident. At that point, the user has the information necessary to begin responding properly and timely to the particular safety incident.

### ADVANTAGES OF THE INVENTION

The previously described versions of the present invention have many advantages, including:

(a) easy recognizability by users because of the stature of the safety station 100 provided by the alarm unit 200's safety post 210 and accentuated by its optional coloration in a bright color;

(b) easy installation at a variety of work environments because of its base 250 with optional mounting variations;

(c) effective warning capability because of its combination visual and audio alarm means (220 and 230);

(d) fast and easy activation by means of its electrical switch(es) 240 that may be made more recognizable by coloring in a bright color;

(e) easily retrievable safety response instructions because of the instructional unit 300 with easily activated display screen 310 located proximate the alarm unit 200;

(f) easily retrievable safety response instructions because of the safety instruction programming organized in a hierarchical and easily understandable manner to allow immediate response by a user, the instructions covering a wide range of types of safety incidents; and,

(g) the ability to function as safety tutorial stations because the instructional unit 300 may be accessed independently of the alarm unit 200 and used for instructional learning at non-incident times.

The present invention does not require that all the advantageous features and all the advantages need to be incorporated into every embodiment thereof.

Although the present invention has been described in considerable detail with reference to certain preferred versions thereof, other versions are possible. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features. For example, the instructional unit 300 is described as being a computer 310 in combination with a display screen 320, but as technology advances the safety procedure instructions may be activated and communicated to users by some other equally effective means. Likewise, the alarm means may comprise a wide variety of visual and audio technologies, and the power supply may vary with technologies and availability.

Therefore, the spirit and scope of the appended claims should not be limited to the description of the preferred versions contained herein.

I claim:

1. A safety station comprising an alarm unit, the alarm unit comprising:
a support post having an at least one sidewall defining a hollow interior, an upper end and a lower end;
a base attached to the lower end of the support post;
a visual alarm means attached to the upper end of the support post and receiving electrical power from a local power source by means of an electronic circuitry disposed internally to the support post;
an audio alarm means attached to the upper end of the support post and receiving electrical power from the local power source by means of the electronic circuitry disposed internally to the support post; and,
an at least one electrical switch capable of assuming an open and a closed position, mounted proximate to the support post and disposed in said electronic circuitry between the visual and audio alarms and the power source to enable activation of said visual and audio alarms when said at least one electrical switch is switched to its closed position

2. The alarm unit of claim 1, wherein the visual alarm means comprises a strobe light.

3. The alarm unit of claim 1, wherein the audio alarm means comprises a siren.

4. The alarm unit of claim 1, wherein the at least one electrical switch comprises an on-off switch.

5. The alarm unit of claim 1, wherein the at least one electrical switch comprises a push-pull switch.

6. The alarm unit of claim 1, wherein the local power source is DC provided by a battery.

7. The alarm unit of claim 1, wherein the local power source is AC provided by a utility company.

8. The alarm unit of claim 7, further comprising a backup secondary power supply comprising a battery to supply power to the alarm unit in the event of a failure in the local power source.

9. The alarm unit of claim 1, wherein the base is adapted to enable the alarm unit to be self-supporting.

10. The alarm unit of claim 1, wherein the base is adapted to be fastened to a surface.

11. The alarm unit of claim 1, wherein the base is adapted for mounting the alarm unit on a plurality of non-smooth substrates.

12. The alarm unit of claim 1, further comprising a communication means mounted to the support post.

13. The safety station of claim 1, further comprising an instructional unit located proximate the alarm unit, the instructional unit comprising a computer from which a plurality of safety response instructions may be retrieved by a user.

14. A safety station, comprising:
an alarm unit comprising:
a support post having an at least one sidewall defining a hollow interior, an upper end and a lower end;
a base attached to the lower end of the support post;
a visual alarm means attached to the upper end of the support post and receiving electrical power from a local power source by means of an electronic circuitry disposed internally to the support post;
an audio alarm means attached to the upper end of the support post and receiving electrical power from the local power source by means of the electronic circuitry disposed internally to the support post;
an at least one electrical switch capable of assuming an open and a closed position, mounted proximate to the support post and disposed in said electronic circuitry between the visual and audio alarms and the power source to enable activation of said visual and audio alarms when said at least one electrical switch is switched to its closed position; and,
an instructional unit located proximate the alarm unit, comprising a computer from which a plurality of safety response instructions may be retrieved by a user.

15. The alarm unit of claim 14, wherein the visual alarm means comprises a strobe light.

16. The alarm unit of claim 14, wherein the audio alarm means comprises a siren.

17. The alarm unit of claim 14, wherein the at least one electrical switch comprises an on-off switch.

18. The alarm unit of claim 14, wherein the at least one electrical switch comprises a push-pull switch.

19. The alarm unit of claim 14, wherein the local power source is DC provided by a battery.

20. The alarm unit of claim 14, wherein the local power source is AC provided by a utility company.

21. The alarm unit of claim 20, further comprising a backup secondary power supply comprising a battery to supply power to the alarm unit in the event of a failure in the local power source.

22. The alarm unit of claim 14, wherein the base is adapted to enable the alarm unit to be self-supporting.

23. The alarm unit of claim 14, wherein the base is adapted to be fastened to a surface.

24. The alarm unit of claim 14, wherein the base is adapted for mounting the alarm unit on a plurality of non-smooth substrates.

25. The alarm unit of claim 14, further comprising a communication means mounted to the support post.

26. The safety station of claim 14, wherein the instructional unit is connected to the support post of the alarm unit.

27. The instructional unit of claim 14, further comprising a touch screen display to enable easy retrieval of the plurality of safety response instructions by a user.

28. The instructional unit of claim 14, wherein the computer is connected via a local area network to a server that provides the plurality of safety response instructions to the computer.

29. The instructional unit of claim 14, wherein the computer is connected via an Internet to a server that provides the plurality of safety response instructions to the computer.

30. A safety instructional unit, comprising a computer from which a plurality of safety response instructions may be retrieved by a user.

31. The safety instructional unit of claim 30, further comprising a touch screen display to enable easy retrieval of the plurality of safety response instructions by a user.

32. The safety instructional unit of claim 30, wherein the computer is connected via a local area network to a server that provides the plurality of safety response instructions to the computer.

33. The safety procedure instructional unit of claim 30, wherein the computer is connected via an Internet to a server that provides the plurality of safety response instructions to the computer.

34. Method for providing safety incident alarm and response instructional capabilities, comprising:
providing an alarm unit, the alarm unit comprising:
a support post having an at least one sidewall defining a hollow interior, an upper end and a lower end;
a base attached to the lower end of the support post;
a visual alarm means attached to the upper end of the support post and receiving electrical power from a local power source by means of an electronic circuitry disposed internally to the support post;
an audio alarm means attached to the upper end of the support post and receiving electrical power from the local power source by means of the electronic circuitry disposed internally to the support post;
an at least one electrical switch capable of assuming an open and a closed position, mounted proximate to the support post and disposed in said electronic circuitry between the visual and audio alarms and the power source to enable activation of said visual and audio alarms when said at least one electrical switch is switched to its closed position; and,
providing an instructional unit located proximate the alarm unit, the instructional unit comprising a computer from which a plurality of safety response instructions may be retrieved by a user.

35. The method for providing safety incident alarm and response instructional capabilities of claim 34, wherein the instructional unit further comprises a touch screen display for activating the computer and for displaying the plurality of safety response instructions.
